(19) United States
(12) Patent Application Publication
(10) Pub. No.: US 2020/0409794 A1
(43) Pub. Date: Dec. 31, 2020

(54) DIAGNOSTICS FOR HIGH-AVAILABILITY SYSTEMS AND DEVICES

(71) Applicant: HEWLETT PACKARD ENTERPRISE DEVELOPMENT LP, Houston, TX (US)

(72) Inventor: Allan Delgado Campos, Heredia (CR)

(21) Appl. No.: 16/454,694

(22) Filed: Jun. 27, 2019

(51) Int. Cl. G06F 11/14

(52) U.S. Cl. CPC G06F 11/142; G06F 2201/82; G06F 11/1417

(57) ABSTRACT

A method for a processing device to recover from a software failure, including: placing the processing device into an inactive state in response to the software failure; reconfiguring a first data memory that the processing device used during the software failure such that the processing device does not overwrite the first data memory data content after the processing device reboots and returns to normal operation; rebooting the processing device using a second data memory; and offloading the data content of the first data memory to an external device after rebooting the processing device.

### BACKGROUND

The term “availability” as used in information technology refers to the ability of a system or device to provide some form of computer-based service. If a user cannot access a system or the system is not otherwise operational, the system is unavailable from a user's point of view. Generally, the term “downtime” refers to periods of time when a system is unavailable. Further, the term “High-Availability” (“HA”) refers to a desired characteristic of a system or device, which aims to minimize downtime and ensure an agreed-upon level of operational performance over an extended period of time. Hospitals and data centers, for example, use high-availability systems and devices to perform routine daily activities as even minor periods of downtime are unacceptable. Generally, high-availability is designed into systems using concepts known in the relevant industry as “clustering” and “redundancy.”

### BRIEF DESCRIPTION OF THE DRAWINGS

The invention may be understood by reference to the following description taken in conjunction with the accompanying drawings, in which like reference numerals identify like elements, and in which:

FIG. 1 depicts an example high-availability system in accordance with one or more examples of the present disclosure.

FIG. 2 depicts a first high-availability processing device in accordance with one or more examples of the present disclosure.

FIGS. 3A-3C together depict two examples of memory address switching for the processing device of FIG. 2 in accordance with the present disclosure.

FIG. 4 depicts a second high-availability processing device in accordance with one or more examples of the present disclosure.

FIGS. 5A-5B together depict an example of memory switching for the processing device of FIG. 4 in accordance with the present disclosure.

FIG. 6 is a flowchart depicting a method for address switching in accordance with one or more examples of the present disclosure.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The methods and systems disclosed below may be described generally, as well as described in terms of specific examples. For instances where references are made to detailed examples, it is noted that any of the underlying principles described are not to be limited to a single example but may be expanded for use with any of the other methods and systems described herein as will be understood by one of ordinary skill in the art unless otherwise specifically stated.

For the purposes of this disclosure, the term “High-availability” (“HA”) refers to the ability of a system or system component to be continuously operational for a desirably long length of time. Availability can be measured relative to “100% operational” or “never failing.” In information technology (“IT”), a widely-held but difficult standard of “high-availability” for a system or device is known as “five 9s” (99.999%) availability.

Unfortunately, even HA systems and devices are subject to both hardware failures and software failures. When the hardware of a device fails, little can be done to support HA except to provide what is known as a “hot spare” whereby a device similar or identical to the failed device is switched from a standby mode to an active mode while the failed device is effectively removed from the system. The “hot spare”, once switched to active mode, then takes over from the failed device.

However, when a device fails due to some form of software error, such as a stack overflow or a processor inadvertently overwriting program instructions, switching out the failed device may not be a viable solution as any “hot spare” will likely be subject to the same conditions that caused the initial software failure. Accordingly, it can be desirable to preserve as much of the data and/or program memory after a software failure such that software engineers can perform a “post mortem” on a failed device so as to determine the source of software error(s) and update a device's operational software to prevent the same or similar software failures in the future.

Unfortunately, performing such “post mortems” typically means that a failed device must remain offline until all the data and/or program memory content is offloaded to some form of external device, such as a software development station/terminal. Such a download might easily take as long as a half-hour depending on the particular circumstances, which is time that the failed device remains inoperable. Such demands for downtime conflict with a desire to immediately reboot the failed device so as to maintain HA standards.

To address this dilemma, the present disclosure uses a multi-part approach whereby the data memory and/or program memory of a failed device is first swapped with other/alternative memory while the failed device is in reset/inactive mode where after the failed device reboots using the other/alternative memory. This allows the failed device to become operational more quickly than is currently attainable. Further, because the formerly used/active memory is not being modified by the now operational device, the contents of such formerly used/formerly active memory may be offloaded to an external device to be later analyzed. Accordingly, both high-availability and failure observability of a device are satisfied.

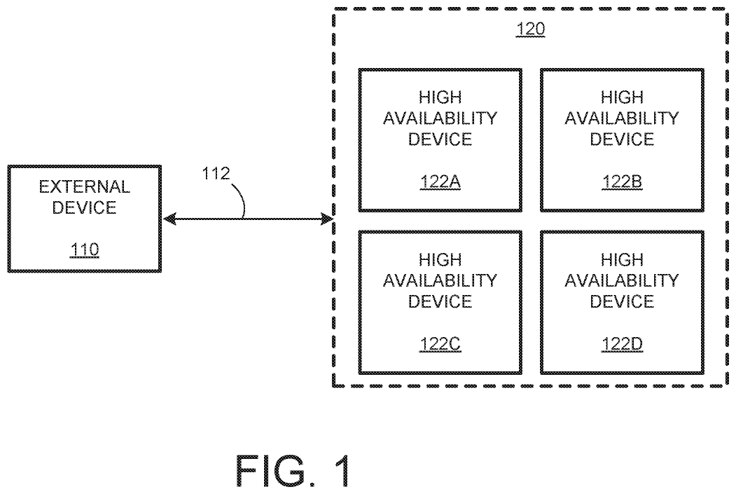

Turning to FIG. 1, an example high-availability system 120 in accordance with one or more examples of the present disclosure is depicted. As shown in FIG. 1, the example high-availability system 120 includes four separate high-availability devices 122A-122D and is communicatively coupled to an example external device 110 over a communication link 112.

The example external device 110 is a developer terminal usable by one or more software engineers to develop and debug software, and can take the form of a stand-alone computer-based system. However, in other examples the external device 110 can be any of, or a combination of, multiple servers, stand-alone-computers, mainframe computers, or any other suitable device or system usable by a user to develop and debug software.

The example high-availability system 120 is an internet-based server usable to provide any number of services, such as sales, searches, social media, etc. However, the purpose of the high-availability system 120 is not limited to any presently-disclosed example and can be any number of systems or devices, such as a system providing a firewall or other security service, a network switch or other communication device, and so on.

The architecture of the example high-availability system 120 can take the form of any one or more of a number of independent processing devices, a cluster-based processing system with load-balancing capability, a system having redundant spare devices, or any known or later-developed system that employs processor-based devices. While the example high-availability system 120 includes four separate high-availability devices 122A-122D, in varying example the high-availability system 120 can employ any number of high-availability devices.

During normal operation, as any one or more of the four separate high-availability devices 122A-122D fails due to a software-based error, the particularly failed high-availability device(s) 122A, 122B, 122C, and/or 122D can perform a reset operation, then reinitialize so as to re-enter normal operation. For the purposes of this disclosure, the term “normal operation” refers to the expected operation of a processing device that is not suffering from some form of software or hardware failure. For example, a processing device of a network switch undergoes “normal operation” by managing those switching operations expected of the network switch.

In addition to resetting the failed device(s), data memory and/or program memory that was actively used during the time that the software failure occurred can be preserved by reconfiguring the memory used such that the reset device(s) will not or cannot access such formerly-used memory. In addition, during boot-up/re-initialization any failed device may perform a register dump to preserve as many internal register states as possible, and either store them in a specially-designated place in memory or send such states to the example developer terminal 110 via some input-output means, such as a serial or parallel communications port.

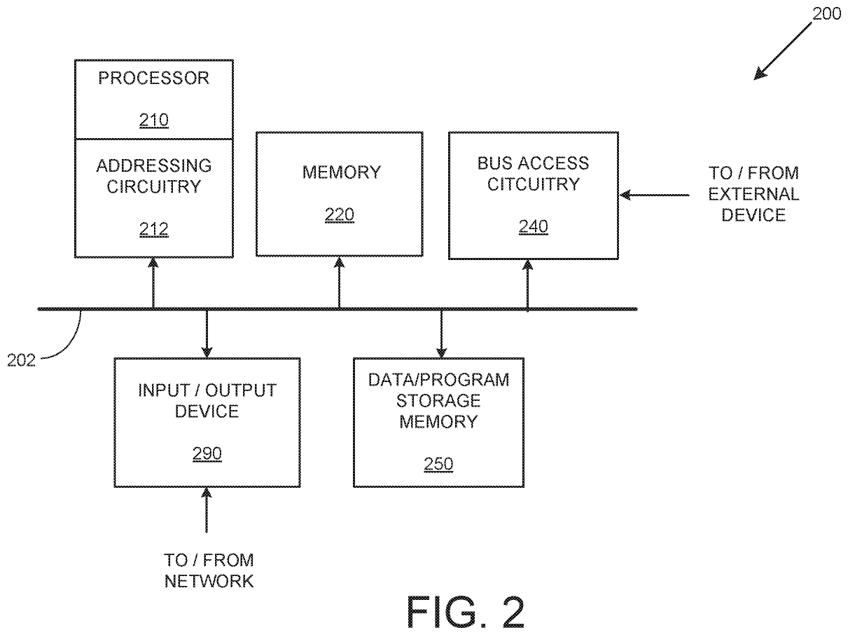

FIG. 2 depicts a first high-availability processing device 200 in accordance with one or more examples of the present disclosure. The high-availability processing device 200 may be used in some examples, for instance, to implement one or more of the high-availability devices 122A-122D shown in FIG. 1. As shown in FIG. 2, the example first high-availability processing device 200 includes a processor 210 (e.g., a central processing unit, or “CPU”, a microprocessor, a processor chipset, or a controller), a memory 220, bus access circuitry 230, a data/program storage memory 240, and an input/output device 290. The above electronic components 210, 220, 230, 240, and 290 are communicatively coupled together by a control/data bus 202.

The example memory 220 can be any type of machine-readable device, such as volatile and non-volatile random access memories. Similarly, the data/program storage memory 240 may be any form of machine-readable device suitable for storing data, such as an optical storage disc, a magnetic storage device, and so on. The example input/output device 290 is a combination of serial and parallel interfaces suitable to allow the first high-availability processing device 200 to interact with a number of external devices, such as a remote computer terminal and/or computer-based equipment.

The example bus access circuitry 230 includes a number of address and data line buffers, along with control circuitry, that together are capable of assuming control of the control/data bus 202 so as to allow an external device, such as the developer terminal, to access the memory 220. Examples of such circuitry include any number of buffers and Direct Memory Access (“DMA”) circuits but for the purposes of this disclosure are not limited to any express example. For instance, in various other examples the memory 220 may be a multiport memory thus alleviating the use of the bus access circuitry to directly access the control/data bus 202.

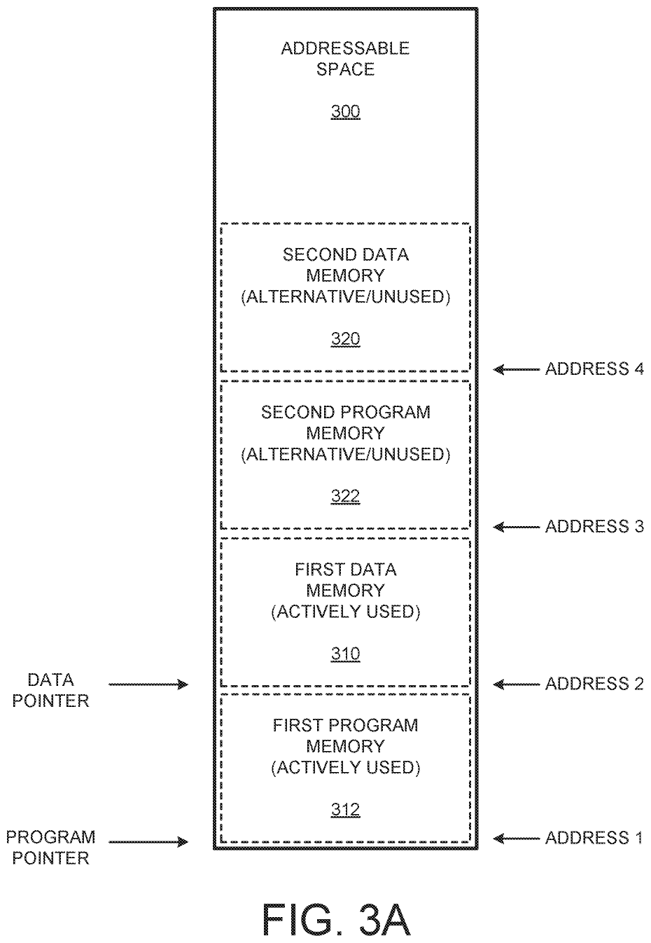

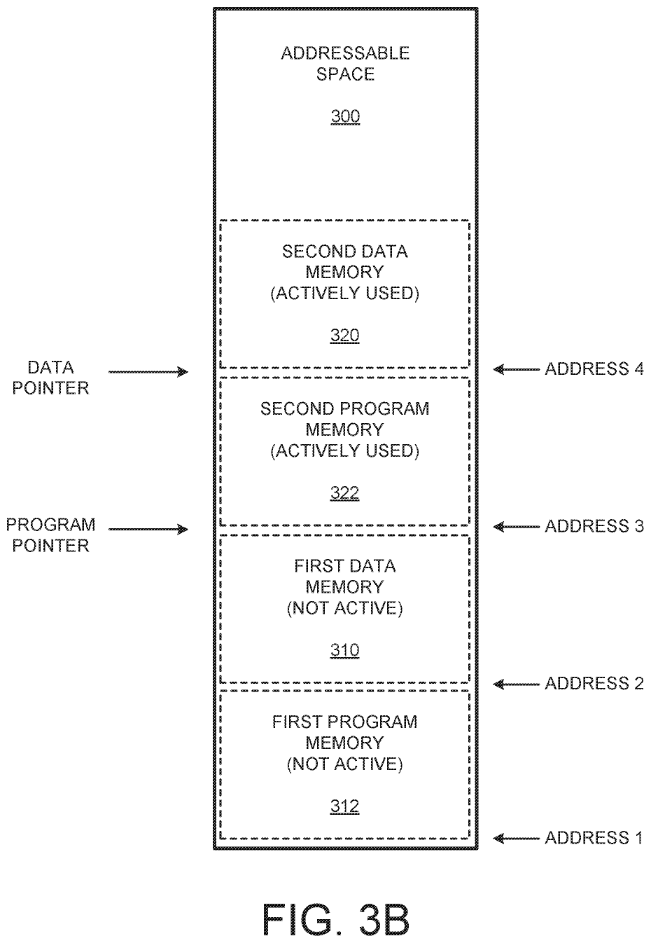

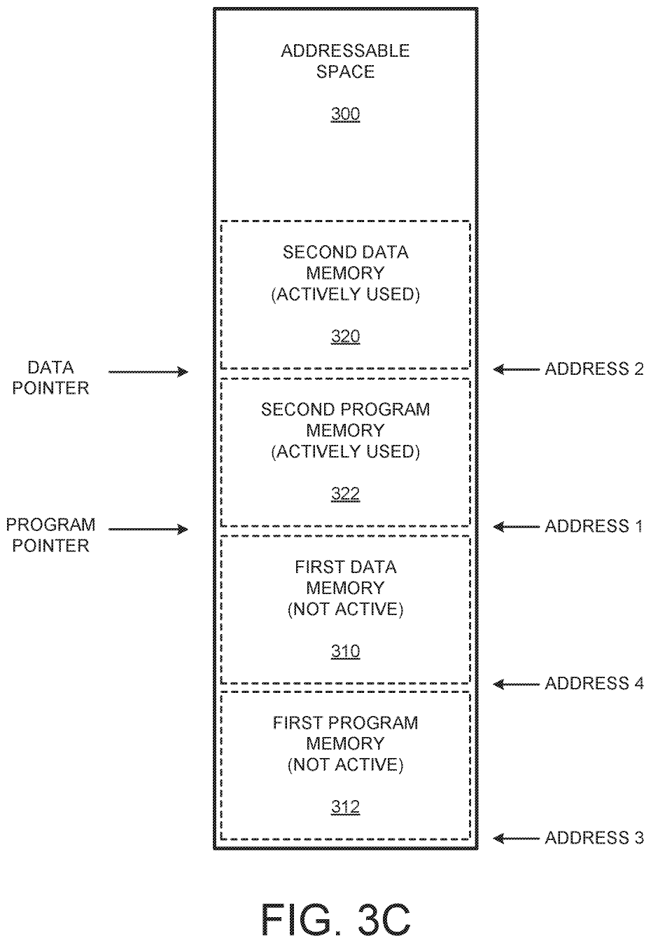

As can be also seen in FIG. 2, the processor 210 includes addressing circuitry 212 that allows the processor 210 to reconfigure the memory 220. FIGS. 3A-3C together depict two examples of address switching of the data/program memory 220 for the processing device of FIG. 2 in accordance with the present disclosure. FIGS. 3A-3C will be discussed in greater detail below.

In operation, as the high-availability processing device 200 initializes so as to perform some number of assigned tasks during normal operation, the processor 210 can transfer any appropriate software in the form of program instructions from the data/program storage memory 240 into a program memory section (not shown) located in the memory 220, and similarly transfer any appropriate data to a data memory section (not shown) located in the memory 220.

Subsequently, the first high-availability processing device 200 may perform its assigned tasks until some form of software error has occurred from which the first high-availability processing device 200 cannot recover. In such circumstances, the first high-availability processing device 200 can go into a reset/reboot (or other inactive state) whereby several operations can occur.

A first operation can include some form of memory reconfiguration whereby the memory used during normal operation, which is herein referred to as the “active” data memory and the “active” program memory, is manipulated such that subsequent processing will not overwrite the content of such memories.

A second operation can include reconfiguring second data and program memories to take the place of the formerly active data and program memories such that, after re-initialization of the first high-availability processing device 200, the processor 210 operates out of the second data and program memories, which allows the first high-availability processing device 200 to quickly return to normal operation without overwriting content in formerly active data and program memories.

The third operation can include the extraction of the content of the formerly active data and program memories by an external device, such as the developer terminal 110 shown in FIG. 1. The third operation can also include storing many or all of the internal registers of the processor 210 in a reserved location in either of the formerly active data and program memories, which may be accomplished using, for example, a specially-designed software routine that operates upon re-initialization. As discussed above, it is envisioned that preserving the content of the formerly active data memory, the formerly active program memory, and the internal processor registers may aid software engineers to determine the cause of software errors and debug software so as to prevent the same or similar software errors from occurring in the future. As is also discussed above, because the processor 210 (post-reboot) is operating out of different memory, returning the first high-availability processing device 200 to normal operation can occur without the delay caused by what can be a time-consuming task of moving as much as tens of millions of words of data and programming to an external device.

As a variation of the example first high-availability processing device 200 of FIG. 2, it is envisioned that, instead of an external device taking control of the control/data bus 202 to access data memory and/or program memory, that the processor 210 may devote a portion of its processing overhead to deliver the appropriate memory contents. For instance, using a dedicated interrupt routine or a command from an external device, the processor 210 may provide any memory content through some communications device, such as a serial or parallel communications interface. In such instances, the bus access circuitry 230 of FIG. 2 may take the form of any form of communications interface, such as an Ethernet connection, a Firewire or other serial communications system, a parallel port, and so on.

Regardless of the manner of data/program content delivery to an external device, the memory manipulation approaches discussed above may remain independent, and further discussion of memory manipulation is provided below with respect to FIGS. 3A-3C.

Turning to FIG. 3A, an example addressable space 300 is shown with four different addressable memories including a first data memory 310, a first program memory 312, a second data memory 320 and a second program memory 322. In an initial normal mode of operation according to one or more examples, a processor, such as the processor 210 of FIG. 2, may include internal addressing registers (not shown) that provide a Data Pointer pointing to the base address (Address 2) of the first (active) data memory 310 and a Program Pointer pointing to the base address (Address 1) of the first (active) program memory 312.

The purpose of such addressing registers is demonstrated in FIG. 3B where the addressing circuitry 212, shown in FIG. 2, can change actively-used data and program memories at will such that, after a software failure, active data memory and active program memory used by a processor may be changed to other memory spaces. In the example of FIG. 3B, the Data Pointer is changed from Address 2 to Address 4 such that the second data memory 320 is actively used by a processor after a reboot. Similarly, the Program Pointer is changed from Address 1 to Address 3 such that the second program memory 322 is actively used by a processor after a reboot. As the Data Pointer and Program Pointers change, the first data memory 310 and the first program memory 312 become unused and (in some examples) inaccessible to the processor.

As an alternative to the manipulation of addressing registers, FIG. 3C depicts an example where the addressable space 300 of FIG. 3A is physically re-arranged such that the first data memory 310 remains at logical Address 2 and the first program memory 312 remains at logical Address 1, but the physical locations of active data and program memories are altered by means of manipulating chip select and/or address lines. Such manipulation can be accomplished by, for instance, manipulating chip select lines if the first data memory 310, first program memory 312, second data memory 320, and second program memory 322 of the addressable space 300 are implemented across different physical chips.

Such manipulation may also be accomplished by, for instance, causing a high-order address line to flip between “0” and “1” such that all memory locations below some location are inaccessible to a processor after a software failure. More particularly, consider a situation where a processor has an addressable memory of 24 bits (0x00000 to 0xFFFFFF) and each memory 310-322 requires only one million distinct address locations (0x100000). By manipulating the third-highest bit external to a processor (using an application-specific integrated circuit (“ASIC”) or other circuitry), the physical addresses to a memory are changed while the logical addresses as seen from the processor are unaffected.

Thus, it is to be appreciated that a processing system or device, such as the example first high-availability processing device 200 of FIG. 2 can include a processor 210, a plurality of memories communicatively coupled to the processor 210, and addressing circuitry 212 that: (1) reconfigures a first (active) data memory 310 and a first (active) program memory 312 that the processing device 200 used during a software failure such that the processor 210 does not overwrite the first data memory 310 and/or the first program memory 312 after the processing device reboots and returns to normal operation, (2) enables an external device, such an the developer terminal 110 of FIG. 1 to offload data content of the first data memory and the first program memory after rebooting the processing device.

Again as discussed above, the addressing circuitry 212 may reconfigure the first data memory 310 and the first program memory 312 by: (1) changing a first programmable pointer that defines data memory for the first high-availability processing device 200, and (2) changing a second programmable pointer that defines program memory for the first high-availability processing device 200.

Also as discussed above, in the alternative, the addressing circuitry 212 may reconfigure the first data memory 310 by logically rearranging data memory for the first high-availability processing device 200 such that the second data memory 320 is logically located at an address formerly used by the first data memory 310. Similarly, the addressing circuitry 212 may reconfigure the first program memory 312 by logically rearranging program memory for the first high-availability processing device 200 such that the second program memory 322 is logically located at an address formerly used by the first program memory 312.

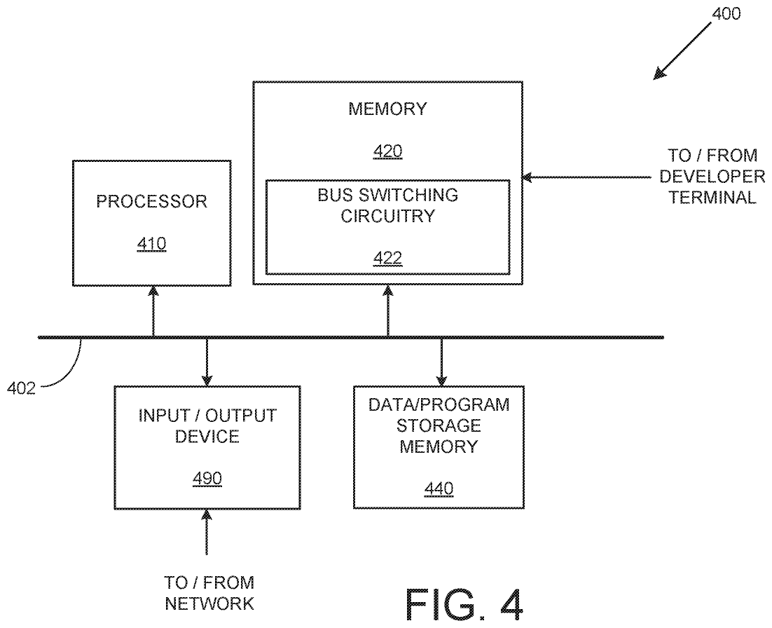

FIG. 4 depicts a second high-availability processing device 400 in accordance with one or more examples of the present disclosure. As shown in FIG. 4, the example second high-availability processing device 400 includes a processor 410 (e.g., a central processing unit, or “CPU”, a microprocessor, a processor chipset, or a controller), a memory 420, a data/program storage memory 440, and an input/output device 490. The above components 410-490 are communicatively coupled together by a control/data bus 402.

As with the first high-availability processing device 200, the example memory 420 of the second high-availability processing device 400 can be any type of machine-readable device, such a volatile and non-volatile random access memories. Similarly, the data/program storage memory 440 may be any form of machine-readable device suitable for storing data, such as an optical storage disc system, a magnetic storage device, and so on. Still further, the example input/output device 490 can a combination of serial and parallel interfaces suitable to allow the second high-availability processing device 400 to interact with a number of external devices, such as a remote computer terminal and/or computer-based equipment.

However, unlike the first high-availability processing device 200 of FIG. 2, the second high-availability processing device 400 does not rely on special bus access circuitry or address manipulation logic, but instead preserves the content of formerly active data and program memory using what is sometimes referred to as a “ping-pong” memory arrangement facilitated by the bus switching circuitry 422 shown in FIG. 4. In the example of FIG. 4, the bus switching circuitry 422 includes a number of three-state buffers (high voltage/low voltage/high-impedance), not separately shown, combined with control logic, also not separately shown, in the form of an ASIC or Field-Programmable Gate Array (“FPGA”). However, it is to be appreciated that the particular form of the bus switching circuitry 422 can take any form so long as such form enable the function described below.

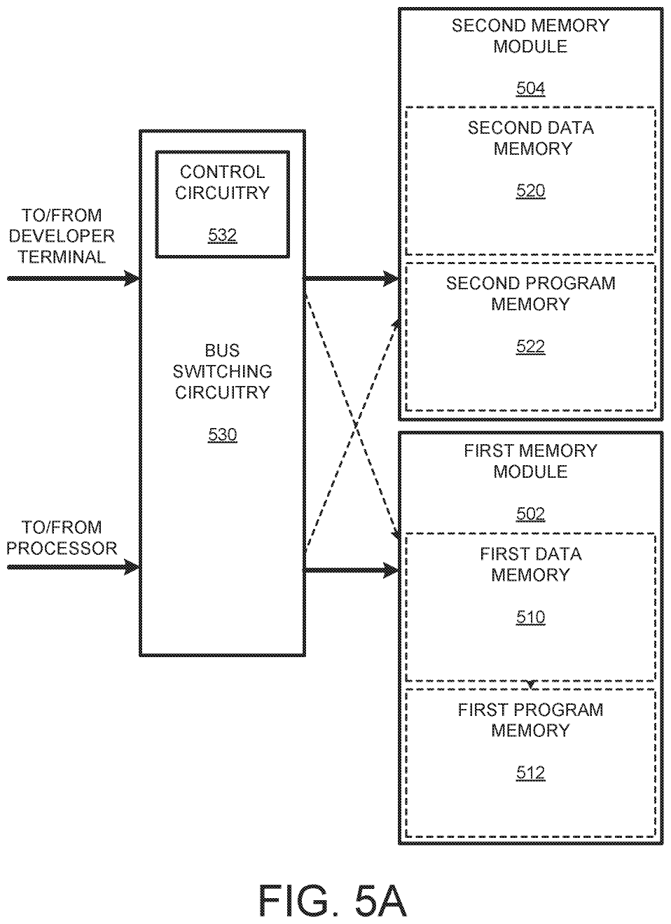

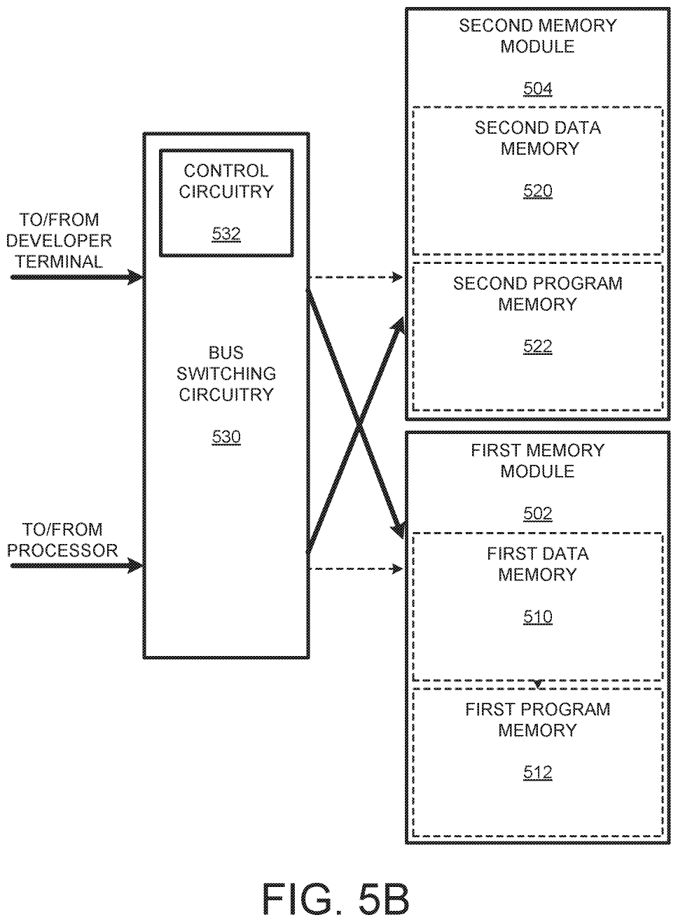

FIGS. 5A-5B together depict an example of memory device switching for the processing device of FIG. 4 in accordance with the present disclosure. As shown in FIG. 5A, a first memory module 502, a second memory module 504, and bus switching circuitry 530 are shown in a configuration that allows a developer terminal and a processor to each access one of the two memory modules 502-504. As is also shown in FIG. 5A, the first memory module 502 includes a first data memory 510 and a first program memory 512 the second memory module 504 includes a second data memory 520 and a second program memory 522, and the bus switching circuitry 530 includes control circuitry 532 that controls and coordinates access to the two memory modules 502-504 such that no two devices access the same memory module at the same time.

In the example of FIG. 5A-5B, the first memory module 502 and second memory module 504 each include one or more memory devices, such a volatile or non-volatile random-access memory, while the bus switching circuitry 530 acts as a multiplexer circuit with two distinct states. In the first state (shown in FIG. 5A) the local processor can access the first memory module 502 while an external device (such as an eternal developer terminal) can access the second memory module 504. In the second state (shown in FIG. 5B) the local processor can access the second memory module 504 while the external device can access the first memory module 502.

Thus it is to be appreciated that a processing system or device, such as the example second high-availability processing device 400 of FIG. 4, can include a processor and a plurality of memory modules communicatively coupled to the processor including the first memory module 502 and the second memory module 504 that: (1) uses switching circuitry 530 to: switch the second memory module 504 for the first memory module 502 such that the processing system or device reboots from the second memory module 504 (FIG. 5B) in response to a software failure occurring while the processor operated using the first memory module 502, and (2) enables offloading of content from the first memory module 502 to an external developer terminal after switching the second memory module 504 for the first memory module 502. Again, as mentioned above, after the switching occurs the switching circuitry 530 can provide exclusive access of the second memory module 504 to the processor while also providing exclusive access of the first memory module 502 to the external developer terminal so as to enable offloading of the content of the (formerly active) data memory 510 and program memory 512 to the external developer terminal.

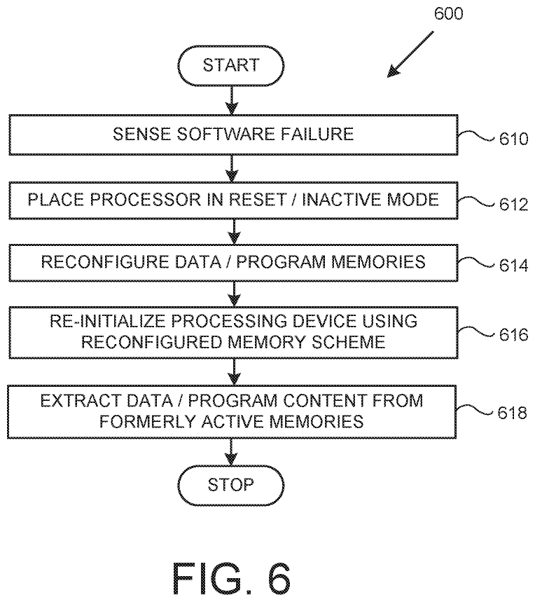

FIG. 6 is a flowchart depicting a method 600 for address switching in accordance with one or more examples of the present disclosure. It is to be appreciated to those skilled in the art in light of this disclosure that, while the various operations 610-618 of FIG. 6 are shown according to a particular order for ease of explanation, that certain operations may be performed in different orders or performed in a parallel fashion. Additionally, certain operations may be omitted in some examples. The method 600 of FIG. 6 assumes an appropriate hardware architecture, such as one of the non-limiting hardware architectures discussed with respect to FIGS. 2 and 4. The method 600 of FIG. 6 also assumes that a processing system or device has incurred a software-based failure and is capable of rebooting/re-initializing to regain normal operation whereby one of more desired operations are again performed.

The method 600 starts in operation 610 where a software failure of a system of device, such as one of the first or second example high-availability processing devices 200 or 400 is sensed.

In operation 612, the system or processor is reset and placed in an inactive mode of operation in response to the software failure. For the purposes of this disclosure it is recognized that a processor may be placed in an inactive state other than a reset state whereby the processor does not affect an external control/data bus. Such inactive states include, for example, what is known as an “idle” state in the relevant arts. Accordingly, even assuming that a system or device has incurred a hardware reset, an “inactive state” of a processor may refer to something other than a reset operation. It is to also be appreciated that a processor may be put into an “idle” or other inactive mode prior to a reset operation.

In operation 614, data and/or program memories may be reconfigured such that a first (active) data memory and/or a first (active) program memory that the processing system or device used during the above-mentioned software failure is not overwritten after the processing system or device reboots/reinitializes and returns to normal operation.

As is discussed above, it is envisioned reconfiguration may take the form of, for example: (1) changing a first programmable pointer that defines data memory for the processing device such that the first programmable pointer points to a second data memory and/or changing a second programmable pointer that defines program memory for the processing device such that the second programmable pointer points to a second program memory; (2) logically rearranging data memory for the processing device such that the second data memory is logically located at an address used by the first data memory and/or logically rearranging program memory for the processing device such that the second program memory is logically located at an address used by the first program memory; and (3) switching a second memory module for a first memory module (holding the formerly active data and/or program memory) using, for example, multiplexing circuitry that provides exclusive access of the second memory module to the processing system or device while also providing exclusive access of the first memory module to the external device.

In operation 616, the subject data processing system or device is reinitialized to return to normal operation using the reconfigured memory scheme.

In operation 618, the content of the data memory and/or program memory of the formerly-active memories is extracted so as to be provided to an external device, such as the developer terminal 110 of FIG. 1.

In various examples the above-described systems and/or methods may be implemented using any form of known or later-developed circuitry (e.g., electronic, optical) or programmable device, such as a computer-based system or programmable logic. It should be appreciated that the above-described systems and methods can be implemented using any of various known or later developed programming/scripting languages, such as “Perl,” “Object Pascal,” “Pascal” “SQL,” “C,” “C++,” “FORTRAN,” “Python,” “VHDL” and the like.

Accordingly, various storage media, such as magnetic computer disks, optical disks, electronic memories or any other form of non-transient computer-readable storage memory, can be prepared that can contain information and instructions that can direct a device, such as a computer, to implement the above-described systems and/or methods. Such storage devices can be referred to as “computer program products” for practical purposes. Once an appropriate device has access to the information and programs contained on the storage media/computer program product, the storage media can provide the information and programs to the device, thus enabling the device to perform the above-described systems and/or methods. Unless otherwise expressly stated, “storage medium” is not an electromagnetic wave per se.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to database-related services.

While the methods and systems above are described in conjunction with specific examples, it is evident that many alternatives, modifications, and variations will be apparent to those skilled in the art. Accordingly, the examples above as set forth herein are intended to be illustrative, not limiting. There are changes that may be made without departing from the scope of the present disclosure.

What is claimed is:

1. A method for a processing device to recover from a software failure, comprising:
placing the processing device into an inactive state in response to the software failure;
reconfiguring a first data memory that the processing device used during the software failure such that the processing device does not overwrite content in the first data memory after the processing device reboots and returns to normal operation;
using a second data memory to process data after the processing device reboots and returns to normal operation; and
offloading the data content of the first data memory to an external device after the processing device returns to normal operation;

2. The method of claim 1, further comprising:
reconfiguring a first program memory used by the processing device during the software failure so that the processing device does not overwrite content in the first program memory after the processing device reboots and returns to normal operation;
using a second program memory to control the processing device after the processing device reboots and returns to normal operation; and
offloading program content of the first program memory to the external device after the processing device returns to normal operation.

3. The method of claim 1, wherein reconfiguring the first data memory includes changing a first programmable pointer that defines data memory for the processing device such that the first programmable pointer points to the second data memory.

4. The method of claim 1, wherein reconfiguring the first data memory includes logically rearranging data memory for the processing device such that the second data memory is logically located at an address used by the first data memory.

5. The method of claim 1, wherein:
the first data memory is located in a first memory module and the second data memory is located in a second memory module; and
reconfiguring the first data memory includes switching the second memory module for the first memory module such that the processing device reboots from second memory module.

6. The method of claim 5, wherein:
data content on the first memory module is offloaded to the external device after switching the second memory module for the first memory module.

7. The method of claim 6, wherein:
switching the second memory module for the first memory module is performed using multiplexing circuitry that provides exclusive access of the second memory module to the processing device while also providing exclusive access of the first memory module to the external device.

8. The method of claim 2, wherein:
reconfiguring the first data memory includes changing a first programmable pointer that defines data memory for the processing device such that the first programmable pointer points to the second data memory; and
reconfiguring the first program memory includes changing a second programmable pointer that defines program memory for the processing device such that the second programmable pointer points to the second program memory.

9. The method of claim 2, further comprising:
reconfiguring the second data memory used by the processing device so that the second data memory is logically located at an address formerly used by the first data memory: and
reconfiguring the second program memory used by the processing device so that the second program memory is logically located at an address formerly used by the first program memory: and

10. The method of claim 2, wherein:
the first data memory is located in a first memory module and the second data memory is located in a second memory module; and
reconfiguring the first data memory includes switching the second memory module for the first memory module such that the processing device reboots from second memory module.

11. The method of claim 10, wherein:
the first program memory is located in the first memory module and the second program memory is located in the second memory module.

12. The method of claim 11, wherein:
switching the second memory module for the first memory module is performed using multiplexing circuitry that provides exclusive access of the second memory module to the processing device while also providing exclusive access of the first memory module to the external device.

13. A processing device, comprising:
a processor; and
addressing circuitry to reconfigure a first data memory that the processing device used during a software failure such that the processor does not overwrite the data content of the first data memory after the processing device returns to normal operation, and
bus access circuitry to provide access to the data content of the first data memory to an external device after the processing device returns to normal operation.

14. The processing device of claim 13, wherein the addressing circuitry further:
reconfigures a first program memory that the processing device used during the software failure such that the processing device does not overwrite content in the first program memory after the processing device returns to normal operation; and
reconfigures a second program memory such that the processing device operates out of the second program memory after the processing device returns to normal operation.

15. The processing device of claim 14, wherein the bus access circuitry further:
provides access to program content of the first program memory to the external device after rebooting the processing device.

16. The processing device of claim 13, wherein the addressing circuitry reconfigures the first data memory by changing a first programmable pointer that defines active data memory for the processing device such that the first programmable pointer points to the second data memory.

17. The processing device of claim 13, wherein the addressing circuitry reconfigures data memory for the processing device such that the second data memory is logically located at an address formerly used by the first data memory.

18. A processing device, comprising:
a processor;
a plurality of memory modules communicatively coupled to the processor including a first memory module and a second memory module, the first memory module including first data memory and the second memory module including a second data memory; and
switching circuitry to:
switch the second memory module for the first memory module such that the processing device reboots from the second memory module in response to a software failure occurring while the processor operated using the first memory module, and
to provide access enable of data content in the first memory module to an external device after switching the second memory module for the first memory module.

19. The processing device of claim 18, wherein:
the switching circuitry includes multiplexing circuitry that provides exclusive access of the second memory module to the processor while also providing exclusive access of the first memory module to the external device.

20. The processing device of claim 19, wherein:
first program memory is located in the first memory module and second program memory is located in the second memory module; and
the switching circuitry provides access of program content to the external device after switching the second memory module for the first memory module.
